(19) United States
(12) Patent Application Publication
(10) Pub. No.: US 2004/0146831 A1
(43) Pub. Date: Jul. 29, 2004

(54) Unit dose delivery system for dental sensitivity product

(75) Inventors: Lorenzo Balmelli, Gentilino (CH); Patrizia Balmelli-Priori, Gentilino (CH); Gert Ulrich Silber, Ponte Capriasca (CH); Beat Kilcher, Bosco Luganese (CH)

Correspondence Address: WOOD, HERRON & EVANS, LLP, 2700 CAREW TOWER, 441 VINE STREET, CINCINNATI, OH, 45202, US

(73) Assignee: KerrHawe SA

(21) Appl. No.: 10/349,666

(22) Filed: Jan. 23, 2003

(51) Int. Cl. A61C 5/04; A61C 5/00

(52) U.S. Cl. 433/89; 433/215

(57) ABSTRACT

A delivery system for administering a metered dose of dental sensitivity product to a tooth includes a reservoir sized to contain a volume of the dental sensitivity product and suited to dispensing the dental sensitivity product in small quantities while maintaining stability of the dental sensitivity product. The system further includes delivery structure in communication with the reservoir and configured to deliver the metered dose of dental sensitivity product. In an exemplary embodiment, the delivery structure includes a cannula and operates to deliver the dental sensitivity product as a spray to the affected tooth when actuated by a user.

### FIELD OF THE INVENTION

The present invention relates to the treatment of dental ailments, and more particularly to a delivery system for administering dental sensitivity product.

### BACKGROUND OF THE INVENTION

The treatment of painful dental ailments by various anti-sensitivity formulations is well known in the art. Formulations may include, for example, potassium nitrate, strontium chloride, stannous fluoride, natrium fluoride, calcium hydroxide and oxalate salts. These various formulations have previously been provided as a thick gel or paste, or in the form of a liquid wash for application to a patient's dental anatomy to thereby treat painful or hypersensitive teeth. In gel or paste form, the formulations are typically applied by a brush to the affected area. When provided as a liquid wash, the patient generally receives a mouthful of the liquid material and swishes it around in his/her mouth to treat the affected area.

The aforementioned forms of dental sensitivity products have various drawbacks. For example, both the gel or paste and wash forms of dental sensitivity products are relatively inconvenient to administer. Specifically, in both forms, the patient must have access to a receptacle for spitting, or otherwise expelling, the dental sensitivity product from his/her mouth after treatment. A user must also carry a brush when the dental sensitivity product is provided as a gel or paste, and thereafter dispose of the brush after the dental sensitivity product has been applied. Moreover, the use of a brush, or other implement, to apply the dental sensitivity product to a tooth by direct contact may cause additional pain to the user. Accordingly, these prior forms of dental sensitivity products are inconvenient to carry and use as needed.

Another drawback of prior forms of providing dental sensitivity products is that they do not provide localized treatment of a patient's sensitive teeth. This is particularly problematic with the wash form, which is generally applied to the entire mouth of a patient. Because the treatment is not localized to the teeth, various side effects, such as bad taste or irritation of the skin or mouth may result. Finally, these forms of providing dental sensitivity product lack the ability to provide precise dosage to an affected tooth.

There is thus a need for a delivery system for a dental sensitivity product which overcomes drawbacks of the prior art, as those described above.

### SUMMARY OF THE INVENTION

The present invention provides a multi-dose delivery system that may be used to provide a metered dose of dental sensitivity product to an individual tooth. The delivery system is provided in a size that is convenient to carry and can be readily used to apply the dental sensitivity product to a tooth at any time it is desired. In one aspect of the invention, the delivery system includes a container with a reservoir sized to contain a volume of the dental sensitivity product suitable for dispensing in small quantities while helping to maintain stability of the dental sensitivity product.

In another aspect of the invention, the delivery system includes delivery structure in fluid communication with the reservoir and configured to deliver the metered dose of dental sensitivity product through a dispensing outlet when actuated by a user. The delivery structure may operate by pumping action or in conjunction with a propellant within the reservoir to dispense the dental sensitivity product as a spray to the affected tooth. The delivery structure may also include a cannula that helps a user to direct the dental sensitivity product to the desired tooth. Accordingly, direct contact with the tooth by an applicator is not necessary, whereby further pain caused by contact with the tooth is avoided. Advantageously, the formulation is a liquid without a diffusion barrier. Thus, the active ingredients are immediately available to the affected tooth upon application.

In another aspect of the invention, the dental sensitivity product disposed within the reservoir comprises a polyalcohol and an anti-sensitivity agent. The dental sensitivity product may also comprise a sweetener, a monohydroxy alcohol, a viscosity increasing agent, a flavoring agent, and other active ingredients. In one exemplary embodiment, the polyalcohol is provided in a quantity of approximately 0.001 percent to 99.9 percent, by weight, of the dental sensitivity product, and the anti-sensitivity agent is provided in a quantity of approximately 0.001 percent to 10 percent, by weight, of the dental sensitivity product.

In another aspect of the invention, a method of treating a sensitive tooth includes providing a delivery system as described above which includes a cannula, positioning the cannula adjacent a tooth, and actuating the delivery structure to dispense dental sensitivity product to the tooth.

In yet another aspect of the invention, a method of providing a delivery system for treating tooth sensitivity includes providing a dispenser as described above, and placing a volume of dental sensitivity product into the dispenser reservoir.

The features of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary dispenser for delivering a dental sensitivity product according to the present invention; and

FIG. 2 is a detailed view depicting use of the dispenser of FIG. 1.

### DETAILED DESCRIPTION

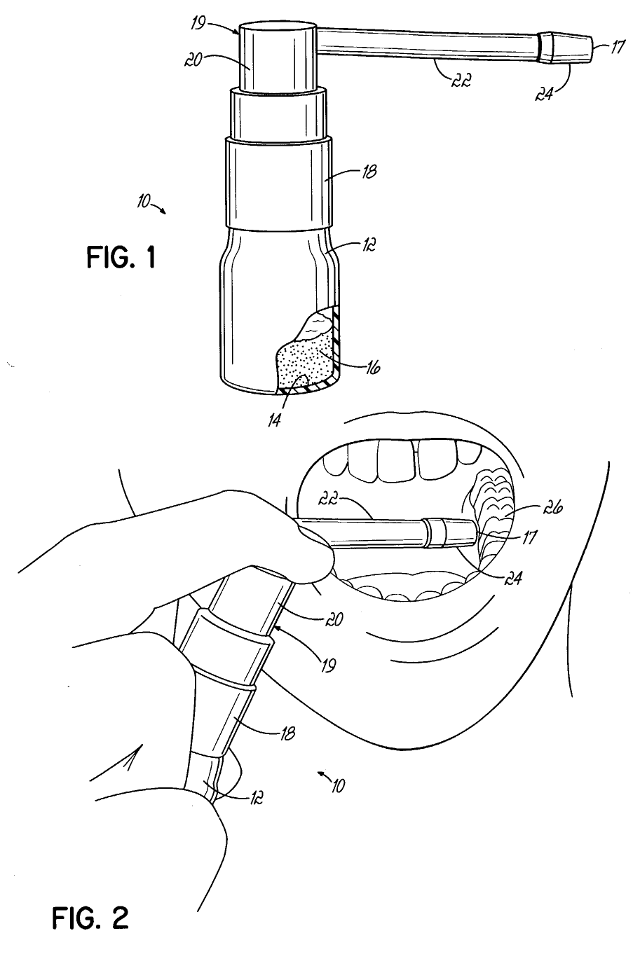

With reference to FIG. 1, there is shown an exemplary dental sensitivity product delivery system 10, according to the present invention. The delivery system includes a container 12 having a reservoir 14 sized to contain a volume of the dental sensitivity product 16. The reservoir 14 is sealed by a closure 18 which includes a dental sensitivity product delivery structure 19 for dispensing a precise dose of the dental sensitivity product 16 through a dispensing outlet 17 to an affected tooth of a patient's mouth. In the embodiment shown in FIG. 1, the delivery structure 19 includes an actuator 20 which may be depressed by the user to dispense the dental sensitivity product 16. The delivery structure 19 further includes a cannula 22 coupled to the actuator 20 and in fluid communication with the reservoir 14 to facilitate directing the dental sensitivity product 16 through the outlet 17 to a desired tooth 26 within the patient's mouth, as depicted in FIG. 2. The delivery structure 19 may further include a nozzle 24 disposed on the end of cannula 22. In an exemplary embodiment, the delivery structure 19 is configured to atomize the dental sensitivity product 16 so that it exits the outlet 17 and is applied to the affected tooth 26 as a spray. Advantageously, the nozzle 24 works in conjunction with the cannula 22 and the actuator 20 to dispense a precise amount of the dental sensitivity product 16 in the form of a spray. Accordingly, the delivery structure 19 permits delivery of a precise dose of dental sensitivity product 16 when actuated by a user.

The dental sensitivity product 16 may be of any known formulation suitable for treating a hypersensitive tooth. In one exemplary embodiment, the dental sensitivity product 16 comprises a liquid organic carrier, preferably a polyalcohol, and more preferably a short chain alcohol, in a quantity of about 0.001% to approximately 99.9%, by weight of the total dental sensitivity product, and an anti-sensitivity agent in a quantity of approximately 0.001% to approximately 50%, by weight of the total dental sensitivity product. More preferably, the dental sensitivity product comprises an anti-sensitivity agent in a quantity of approximately 10% by weight of the total dental sensitivity product. The formulation may further include a sweetener, a monohydroxy alcohol, a viscosity increasing agent, a flavoring agent, and other active ingredients. In an exemplary embodiment, the sweetener, the viscosity increasing agent, and the flavoring agent are each provided in quantities of approximately 0-10%, by weight of the total dental sensitivity product, and the monohydroxy alcohol is provided in a quantity of approximately 0-30%, by weight of the total dental sensitivity product, wherein the cumulative weight percentage of the various ingredients of the total dental sensitivity product is 100%. In a preferred embodiment, the formulation comprises approximately 0.001-99.9% polyalcohol and 0.001-0.6% anti-sensitivity agent, by weight of the total dental sensitivity product. The formulation may further include up to about 5% each of sweetener and viscosity increasing agent, up to about 10% monohydroxy alcohol, and up to about 2% flavoring agent, by weight of the total dental sensitivity product. In all formulations, the dental sensitivity product is substantially free of water. By “substantially free” it is meant that water is not intentionally added to the formulation. It may be understood, however, that water may be present as an impurity, but preferably in an amount less than 5%, and more preferably less than 2%, by weight of the total dental sensitivity product.

The following example illustrates an exemplary formulation useful in practicing the present invention. Neither this example nor any of the foregoing disclosure should be construed as limiting in any way the scope of the present invention. Unless otherwise indicated, all parts and percentages are by weight.

| | | Conc. |
|---|---|---|
| No. | Names of Ingredients (INCI) | [% (w/w)] |
| 1 | Propyleneglycol | 96.86 |
| 2 | Aspartame | 0.35 |
| 3 | Monohydroxy Alcohol | 2.00 |
| 4 | Stannous Fluoride | 0.44 |
| 5 | PVP | 0.00 |
| 6 | Aroma 76168/34 | 0.35 |
| 7 | Other active ingredient | 0.00 |
| | TOTAL | 100.00 |

In an exemplary embodiment, the container 12 is formed from a material which is chemically compatible with the dental sensitivity product 16. Specifically, the container material should not cause an adverse reaction with the dental sensitivity product 16. For example, when the dental sensitivity product 16 includes stannous fluoride, the container 12 should not be made of glass or other material known to react with the stannous fluoride. The container 12 should also be impervious to air and moisture so that the container 12 helps to ensure the stability and efficacy of the dental sensitivity product 16.

As mentioned above, the reservoir 14 should be sized to contain a volume of dental sensitivity product 16 suitable for dispensing in unit dose quantities and to help maintain the dental sensitivity product 16 in a stable condition. In this regard, if the reservoir 14 is too large, the dental sensitivity product 16 may be prone to stability problems as the volume of dental sensitivity product 16 remaining in the reservoir 14 gradually decreases with dispensing of the dental sensitivity product 16. In one exemplary embodiment, the reservoir 14 is sized to contain approximately 10-20 ml of dental sensitivity product 16. Advantageously, this volume of dental sensitivity product 16, in conjunction with the spray delivery structure 19, helps to enhance the stability of the dental sensitivity product 16 throughout its use.

In another exemplary embodiment, the delivery structure 19 is configured to dispense a volume of dental sensitivity product 16 no greater than approximately 100 μl when actuated by a user. The delivery structure 19 may be of any known type suitable for providing the dental sensitivity product 16 in a precise quantity of spray to a desired tooth 26. For example, the delivery structure 19 may operate by pumping action, or may work in conjunction with a propellant disposed within the reservoir 14 to dispense the spray. In an exemplary embodiment, the propellant may be contained in the reservoir 14 such that it is not in contact with the dental sensitivity product 16. For example, the propellant may be separated from the dental sensitivity product 16 by a flexible barrier such as a membrane or a bag.

In another aspect of the invention, a method of treating a sensitive tooth 26 includes providing a delivery system 10 having a reservoir 14 sized to contain a volume of dental sensitivity product 16 and having delivery structure 19 including a cannula 22 and an outlet 17 in communication with the reservoir 14 and configured to deliver a metered dose of dental sensitivity product 16 through the cannula 22 and outlet 17, positioning the cannula 22 with outlet 17 adjacent an affected tooth 26, and actuating the delivery structure 19 to dispense dental sensitivity product 16 through the cannula 22 and outlet 17 to the tooth 26.

In another aspect of the invention, a method of providing a delivery system 10 for treating tooth sensitivity includes providing a dispenser, as described above, and placing a volume of dental sensitivity product 16 within a reservoir 14 of the dispenser. The method may further include placing a propellant gas within the reservoir 14 or placing an inert gas within the reservoir. In an exemplary embodiment, the dental sensitivity product 16 is placed within the reservoir 14 under inert gas conditions to ensure the stability and efficacy of the dental sensitivity product 16.

While the present invention has been illustrated by the description of the various embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A delivery system for a dental sensitivity treatment product, comprising:
a reservoir sized to contain a volume of dental sensitivity product and formed from material that is chemically compatible with the dental sensitivity product;
dental sensitivity product disposed within said reservoir, said dental sensitivity product including a liquid organic carrier and an anti-sensitivity agent; and
delivery structure including a dispensing outlet, said delivery structure in fluid communication with said reservoir and configured to deliver a metered dose of dental sensitivity product through said outlet when actuated by a user.

2. The delivery system of claim 1, wherein said delivery structure includes a cannula.

3. The delivery system of claim 1, further comprising a propellant gas disposed within said reservoir and operable to facilitate dispensing of said dental sensitivity product when said delivery structure is actuated by a user.

4. The delivery system of claim 3, wherein said propellant gas is separated from said dental sensitivity product by a flexible barrier.

5. The delivery system of claim 1, further comprising an inert gas disposed within said reservoir and adapted to increase the stability of said dental sensitivity product.

6. The delivery system of claim 1, wherein said delivery structure is configured to atomize said dental sensitivity product.

7. The delivery system of claim 1, wherein said liquid organic carrier is a polyalcohol and wherein said dental sensitivity product comprises polyalcohol in a quantity of approximately 0.001 to approximately 99.9 percent, by weight of the dental sensitivity product.

8. The delivery system of claim 1, wherein said dental sensitivity product comprises an anti-sensitivity agent in a quantity of approximately 0.001 to approximately 50.0 percent, by weight of the dental sensitivity product.

9. The delivery system of claim 8, wherein said anti-sensitivity agent is in a quantity of approximately 0.001 to approximately 0.6 percent, by weight of the dental sensitivity product.

10. The delivery system of claim 1, wherein said delivery structure is configured to dispense a volume of dental sensitivity product not greater than approximately 100 μl when actuated by a user.

11. The delivery system of claim 1, wherein said reservoir is sized to contain up to approximately 20 ml of dental sensitivity product.

12. A method of treating a sensitive tooth in a patient's mouth, comprising:
providing a delivery system including:
a reservoir sized to contain a volume of dental sensitivity product and formed from material that is chemically compatible with the dental sensitivity product,
dental sensitivity product disposed within the reservoir, the dental sensitivity product including a polyalcohol and an anti-sensitivity agent, and
delivery structure including a cannula with a dispensing outlet, the delivery structure in fluid communication with the reservoir and configured to deliver a metered dose of dental sensitivity product through the cannula and outlet when actuated by a user,
positioning the cannula in a patient's mouth with the dispensing outlet adjacent a sensitive tooth; and
actuating the delivery structure to dispense dental sensitivity product to the sensitive tooth through the cannula and outlet.

13. The method of claim 12, further comprising dispensing the dental sensitivity product to the tooth as a spray.

14. A method of providing a delivery system for treating tooth sensitivity, the method comprising:
providing a dispenser, including:
a reservoir sized to contain a volume of dental sensitivity product and formed from material that is chemically compatible with the dental sensitivity product, and
delivery structure, including a cannula in fluid communication with the reservoir, the delivery structure configured to deliver a metered dose of dental sensitivity product through the cannula when actuated by a user; and
placing a volume of dental sensitivity product within the reservoir.

15. The method of claim 14, further comprising:
placing a propellant gas within the reservoir.

16. The method of claim 14, further comprising:
placing an inert gas within the reservoir.

17. The method of claim 14, wherein the dental sensitivity product is placed in the reservoir while exposed to inert gas.

18. The method of claim 14, wherein dental sensitivity product is placed in the reservoir using a propellant gas.
